(19) United States
(12) Patent Application Publication
(10) Pub. No.: US 2005/0237386 A1
(43) Pub. Date: Oct. 27, 2005

(54) Underwater mask camera

(76) Inventor: Jason M. Sandos, Salt Lake City, UT (US)

Correspondence Address: Jason Sandos, 5545 W. Lodestone Ave., Salt Lake City, UT, 84118, US

(21) Appl. No.: 11/108,468

(22) Filed: Apr. 18, 2005

Related U.S. Application Data
(60) Provisional application No. 60/563,119, filed on Apr. 19, 2004.

(51) Int. Cl. H04N 7/18

(52) U.S. Cl. 348/81

(57) ABSTRACT

The MaskCam provides a hand's free solution for underwater photography & video. This invention incorporates an underwater mask and a camera together that can easily be placed on the face of the operator (i.e. scuba divers, snorkelers, swimmers) to provide a clear view of the surroundings as well as the ability to take photographs and video of anything that the operator is viewing through the transparent plate of the mask. This invention simplifies the use of a camera underwater while keeping the hands free for other activities such as swimming or adjusting gear.

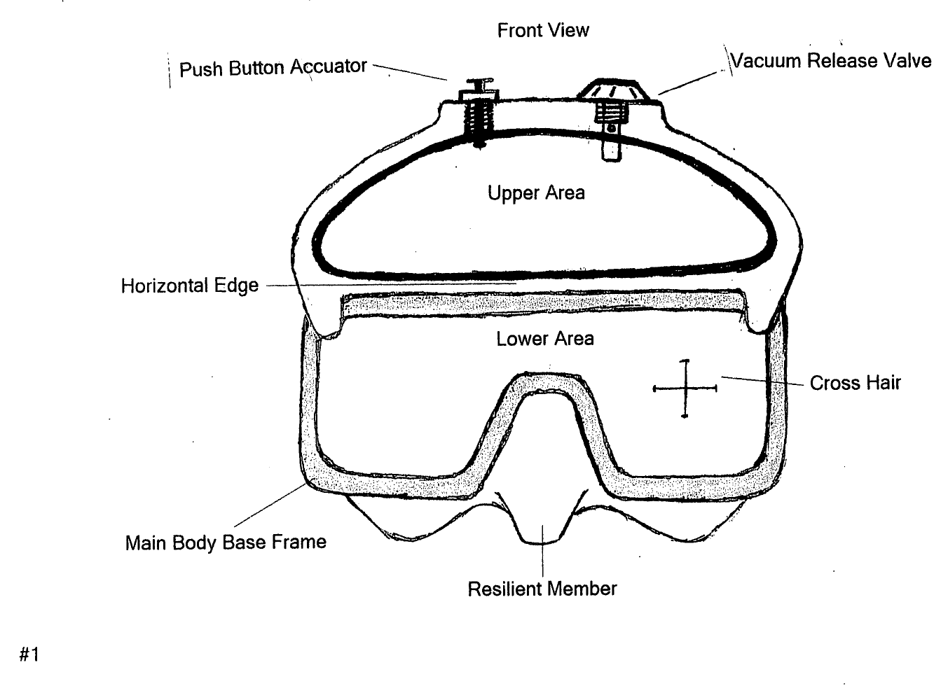

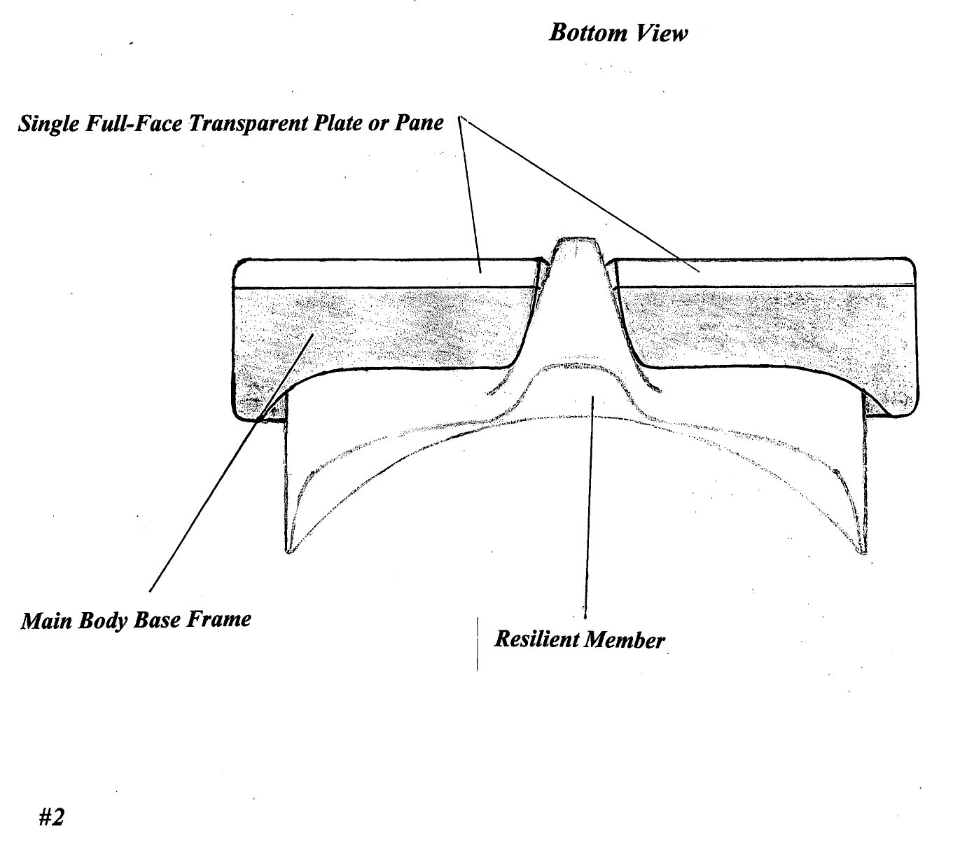

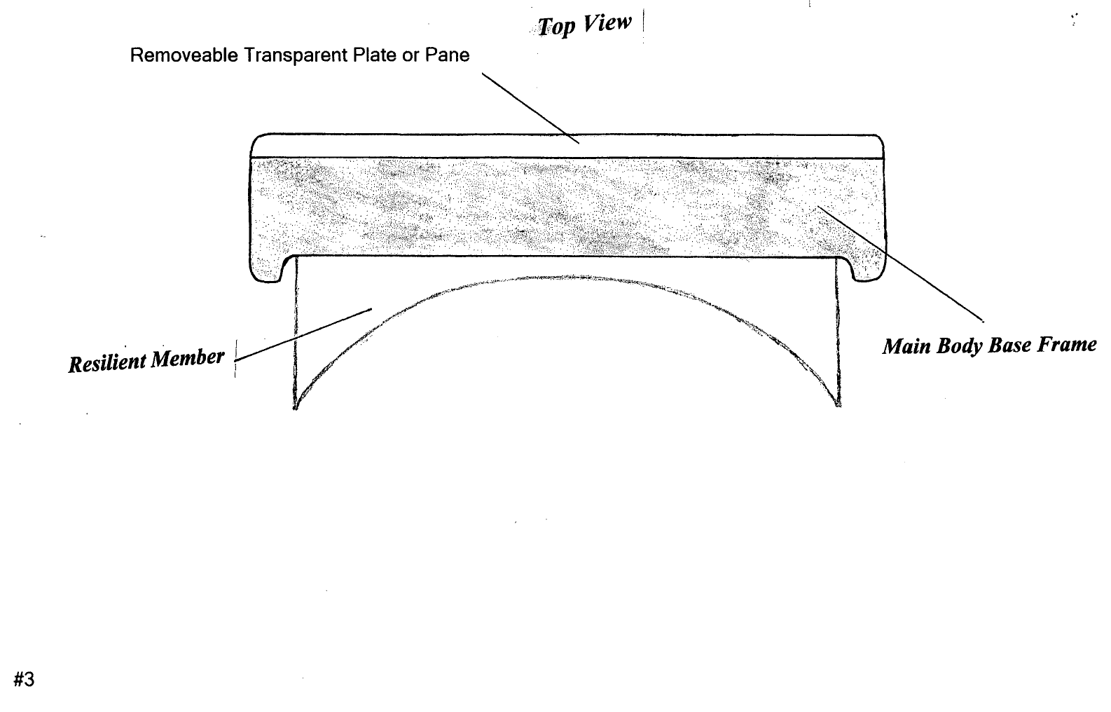

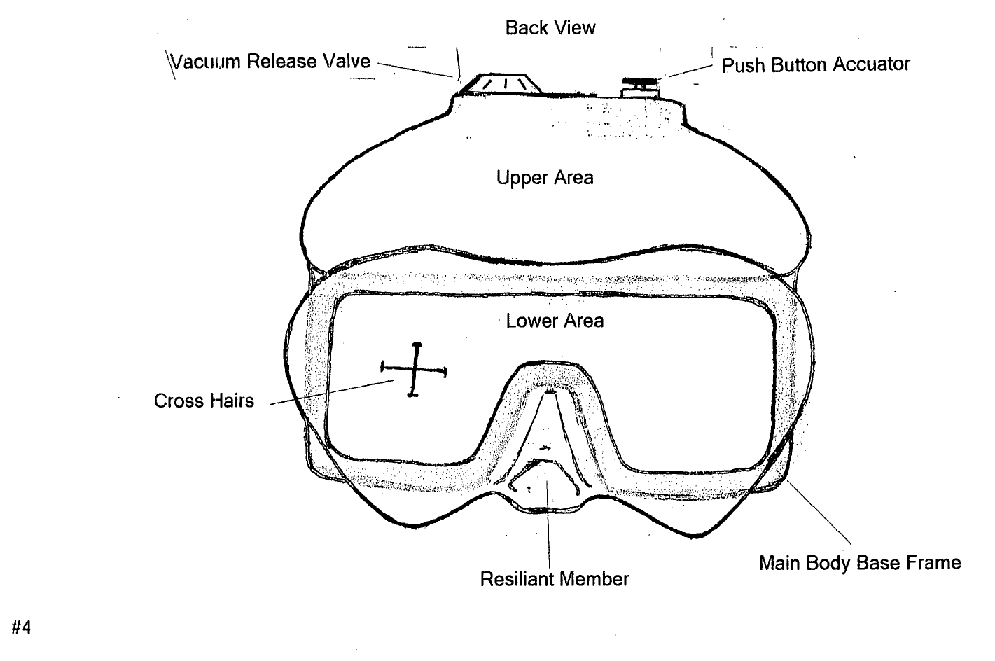

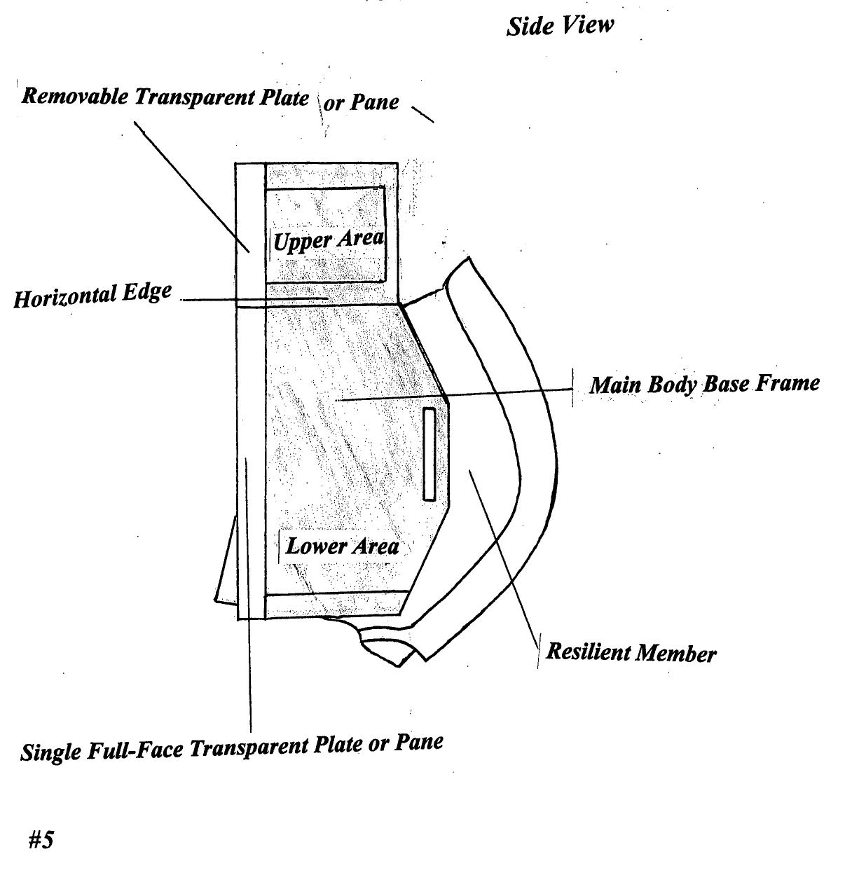

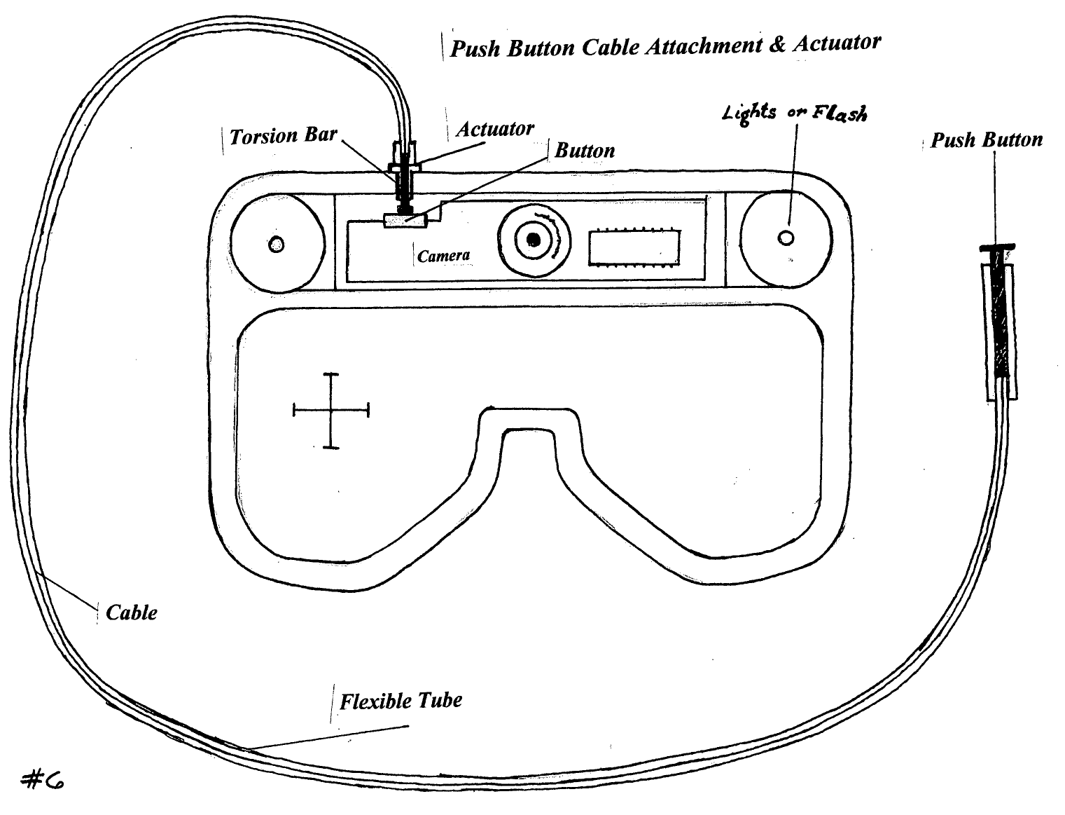

### CROSS-REFERENCE TO RELATED APPLICATIONS

This Utility Patent application filed on Apr. 18, 2005, application Ser. No. 11/108,468, claims the benefits of the earlier Provisional application filed on Apr. 19, 2004, application No. 60/563,119.

### BACKROUND OF THE INVENTION

Jason Sandos conceived this invention idea while scuba diving in the Caribbean in November of 2003 to simplify underwater photography and video by combining a scuba mask with an underwater camera housing.

### BRIEF SUMMARY OF THE INVENTION

The present invention generally relates to underwater photography & video. More specifically, the present invention provides a hand's free solution for underwater photography & video. This invention incorporates an underwater mask and a camera together that can easily be placed on the face of the operator (i.e. scuba divers, snorkelers, swimmers) to provide a clear view of the surroundings as well as the ability to take photographs and video of anything that the operator is viewing through the transparent plate or pane of the mask. This invention simplifies the use of a camera underwater while keeping the hands free for other activities such as swimming or adjusting gear. The Underwater Mask Camera alleviates inconvenient and unnecessary movements. Clearly, such an apparatus would be a useful and desirable device.

The foregoing description of a preferred embodiment of the invention has been given by way of example and not of limitation. Understandably, many changes and modifications may be made thereunto within the scope of the inventive concept.

The description of this invention will become more clearly apparent from the drawings associated with the preferred embodiment of the invention.

### BRIEF DESCRIPTION OF THE SEVERAL VIEWS OF THE DRAWING

#1 Front View

#2 Bottom View

#3 Top View

#4 Back View

#5 Side View

#6 Full View Encompassing (Push Button Cable Attachment Actuator, Digital or Film Camera & Flash or Lights)

### DETAILED DESCRIPTION OF THE INVENTION

The Underwater Mask Camera should be made of clear high-density plastic, glass and other like materials that provide strength to high pressures and clear transparency for vision. The Underwater Mask Camera consists of a main body base frame with an upper area and a lower area, which are divided by the upper areas lower edge and the lower areas upper edge and creates a horizontal edge between the two areas. The upper area may also be separate from the lower area to have the ability to attach to any scuba mask.

The upper area contains a hollow interior for positioning of a camera and flash or lights therein. The hollow interior is bound by an upper edge, a lower edge, and outer side edges. On the front of the upper area, these edges provide support for a single full-face transparent plate or pane that allows the camera to take photographs or video. On the front or back of the upper area, these edges provide support for a removable transparent plate or pane with a rubber seal, which enables access to the camera and flash or lights therein. The front and back transparent plates of the upper area sit perpendicular to the operator's forehead. This upper area is a watertight shell with inside and outside surfaces and an opening extending between the surfaces. An actuator is disposed in the opening. The actuator has an outer member disposed external to the opening and an inner member disposed internal to the opening. The actuator has a torsion bar joining the members to the watertight shell. The members are pivot able about an axis through the torsion bar, between an initial orientation and a pivoted orientation. The torsion bar is relaxed when the members are in the initial orientation and tensioned when the members are in the pivoted orientation. A facing is united with the watertight shell and the actuator, this facing seals the opening. A push button waterproof switch is attached to one end of a cable. The push button pushes on the cable inside of a flexible tube. The other end of the flexible tube is adapted for placement over the said external outer member and the cable is attached to the said external outer member of the actuator. The said internal inner member of the said actuator is placed over the record button of the camera therein.

The lower area of the base frame consists of an upper edge, a lower edge with a symmetry mid-axis at the nose, and outer side edges. On the front of the lower area, these edges provide support for a single full-face transparent plate or pane, which sits perpendicular to the operator's face. A resilient member connects to the back of the lower area and conforms to the diver's face around the eyes and nose area. This lower area provides an opening for the operator's eyes. The said transparent plate or pane will have a Cross Hair to align the operator's sight in the lower area with the camera lens in the upper area so that the operator can capture photographs or video of anything being viewed.

The description of this invention will become more clearly apparent from the drawings associated with the preferred embodiment of the invention.

1) I claim that this invention simplifies the use of a camera underwater by providing a hands free solution for underwater photography and video

2) I claim that this invention may be a separate unit that can be attached to a variety of scuba masks

3) I claim that this invention may be a solid unit which includes both mask and camera housing
